(19) United States
(12) Patent Application Publication
(10) Pub. No.: US 2017/0029344 A1
(43) Pub. Date: Feb. 2, 2017

(54) DEVICE AND METHOD FOR PRODUCING FERTILIZER FROM THE EXHAUST GASES OF A PRODUCTION SYSTEM

(71) Applicant: Heinz TISCHMACHER, Plankstadt (DE)

(72) Inventor: Heinz TISCHMACHER, Plankstadt (DE)

(21) Appl. No.: 15/302,575

(22) PCT Filed: Apr. 8, 2015
(86) PCT No.: PCT/EP2015/057569

§ 371 Date: Oct. 7, 2016

(30) Foreign Application Priority Data
Apr. 9, 2014 (DE) 10 2014 105 030.4

(51) Int. Cl. C05C 3/00; B01D 53/54; B01D 53/56; B01D 53/50; B01D 9/00; C01C 1/24; B01D 53/78; B01D 53/60; C05C 1/00; C01C 1/26; C01C 1/18; B01D 53/62; B01D 53/75

(52) U.S. Cl. CPC C05C 3/00; B01D 53/62; B01D 53/54; B01D 53/56; B01D 53/50; B01D 9/0013; B01D 53/75; B01D 53/78; B01D 53/60; C05C 1/00; C01C 1/26; C01C 1/185; C01C 1/24; B01D 2251/106; B01D 2251/104; B01D 2251/10; B01D 2258/0233; B01D 2258/025; B01D 2251/2062

(57) ABSTRACT

A device and a method produces fertilizer from the exhaust gases of a production system, for example a system for producing cement. The exhaust gases are completely converted such that the exhaust gases are not released into the environment. For this purpose, the exhaust gases are introduced directly into the device from the production system. Exhaust gases such as NOₓ and/or SO₂ are first oxidized in the device and then reprocessed into NH₄NO₃ or (NH₄)₂SO₄. CO₂ is reprocessed into NH₄HCO₃ in the device while nitrogen is converted into ammonia, and the ammonium, among others, is used to produce NH₄HCO₃ from CO₂.

The invention relates to an apparatus and to a method for the production of fertilizers from exhaust gases of a production system.

A large amount of exhaust gases continues to get into the atmosphere from production systems, for example systems for cement production. The CO₂ footprint, in particular, has gained increasing importance in recent years, because CO₂ is classified as a greenhouse gas. In this regard, attempts have been made in recent years to counteract the increasing CO₂ emissions by means of corresponding countermeasures, for example by means of rain forest reforestation or CO₂ storage systems. However, such countermeasures are not only very expensive, but also, in part, also very controversial—for example as far as CO₂ storage systems are concerned.

It is therefore the task of the present invention to make an apparatus and a method available, with which it is possible to utilize the total exhaust gas of a production system in practical manner, without any exhaust gases having to be released into the atmosphere.

This task is accomplished by means of an apparatus and a method, wherein
a) in a first container of the apparatus, an oxidation agent is made available in an aqueous acid, wherein
b) an exhaust gas containing CO₂, N₂ as well as NOₓ and/or SO₂, which gas comes from a production system, is passed into the first container, wherein
c) NOₓ and/or SO₂ are oxidized, while CO₂ and N₂ are conducted into a second container, and wherein
d) in the second container, CO₂ reacts with a solution containing NH₃ presented in the second container, to form ammonium hydrogen carbonate.

The invention therefore relates to an apparatus for the production of fertilizers from exhaust gases of a production system, wherein the apparatus obtains the exhaust gases directly from the corresponding production system. Such production systems can be, for example, a system for the production of cement. The apparatus has a first container, which is connected with the production system by way of a first line. In this regard, an exhaust gas from the production system is introduced into the first container by way of this first line. This exhaust gas can contain N₂, CO₂ as well as NOₓ and/or SO₂, wherein in the first container, N₂ and CO₂ can be separated from NOₓ and/or SO₂. The first container is connected with a second container by way of a second line, wherein CO₂ and N₂ can be transferred to the second container by way of the second line. A solution containing NH₃ can be introduced into the second container by way of a third line, wherein the temperature in the second container can be adjusted in such a manner that NH₃ and CO₂ react in the solution to form ammonium hydrogen carbonate. This ammonium hydrogen carbonate can be used as a fertilizer. It is advantageous, in this connection, that the entire CO₂ is processed to form ammonium hydrogen carbonate, and therefore it no longer gets into the atmosphere as an exhaust gas.

It is furthermore advantageous that such apparatuses can be set up directly next to the corresponding production systems. It is also possible that exhaust gases of multiple production systems are processed in this apparatus to produce fertilizers. Aside from fertilizers, products that can be used as educts for fertilizer production or as educts in the production system can also be produced.

In the first container, an oxidation agent is provided, which oxidizes NOₓ and/or SO₂, wherein the corresponding oxidation products of NOₓ and/or SO₂ remain in solution. In this regard, a peroxide, for example H₂O₂, can be used as the oxidation agent. The solution in which the oxidation agent is contained is preferably an aqueous acid and, particularly preferably, an aqueous solution of H₂SO₄. These gases are therefore completely removed from the gas mixture that contains CO₂.

The solution containing ammonium hydrogen carbonate is transferred to a crystallization apparatus by way of a fourth line. In this crystallization apparatus, ammonium hydrogen carbonate is precipitated. Subsequently, ammonium hydrogen carbonate can still be recrystallized in this solution, so that finally, pure ammonium hydrogen carbonate is obtained. This ammonium hydrogen carbonate is characterized by very good fertilizer properties.

The acidic solution with the oxidation products NOₓ and/or SO₂ is transferred from the first container to a third container, for example by pumping it off. In the third container, this acidic solution is neutralized by means of a solution containing NH₃. It is advantageous, in this connection, that these oxidation products can also be processed further to produce fertilizers.

The solution containing NH₃ is situated in a tank storage unit. This tank storage unit is connected with the second container by way of the third line and with the third container by way of a fifth line. This is a very simple structure.

The production system is preferably a system for cement production. However, the production system can also be a system for the production of metals. In this case, the exhaust gas would be smelter smoke. It is therefore advantageous that this production system for the production of fertilizers can be connected with any system in which CO₂ occurs.

The oxidation agent is preferably peroxide, ozone or permanganate. These oxidation agents possess good oxidation properties and can be obtained inexpensively. Particularly preferably, KMnO₄ is used, because this oxidation agent is nontoxic and therefore easy to handle.

The invention relates to a method for the production of fertilizers from exhaust gases of a production system, for example from exhaust gases of a system for cement production. In this regard, the method comprises the following consecutive steps:
a) in a first container, an acidic solution containing an oxidation agent is made available;
b) an exhaust gas that comes from the production system is passed into the first container, wherein the exhaust gas contains CO₂, as well as NOₓ and/or SO₂;
c) NOₓ and/or SO₂ are oxidized in the first container, while CO₂ and N₂ are conducted into a second container;
d) in the second container, CO₂ reacts with a solution containing NH₃ presented in the second container, to form ammonium hydrogen carbonate.

It is advantageous, in this regard, that the entire CO₂ is processed further to produce a fertilizer, and therefore is not emitted into the atmosphere.

The solution containing ammonium hydrogen carbonate is subsequently passed into a crystallization apparatus. There, ammonium hydrogen carbonate crystallizes out at about 281 to 283 K. If ammonium hydrogen carbonate crystallizes out at these temperatures, a high yield can be expected.

Afterward, recrystallization still takes place, if applicable, and thereby very pure ammonium hydrogen carbonate is obtained.

After ammonium hydrogen carbonate has crystallized out and was recrystallized, if applicable, the solid is separated from the solution, so that a solid having only a slight proportion of water is obtained.

After the solution was removed, the solid is dried. The ammonium hydrogen carbonate obtained in this way can then either be stored in a storage unit or can be provided with further additives that further improve the fertilizing properties or the storage properties of the fertilizer.

It is advantageous if is not simply given off into the atmosphere, but rather processed further to produce NH₃. For this purpose, N₂ is removed from the second container and passed into a reactor containing CaC₂. In this reactor, N₂ reacts with CaC₂ to form CaCN₂. Subsequently, CaCN₂ is introduced into a further reactor and mixed with hot steam, wherein CaCN₂ is hydrolyzed, and CaCO₃ and NH₃ are formed. If N₂ is processed further to produce NH₃, a process is made available in which all the required educts for the production of ammonium hydrogen carbonate are derived from exhaust gases of the production system.

In this regard, the CaCO₃ that has formed can be passed back into the production circuit as an educt. However, it is also possible that CaCO₃ is removed from the process and used as a fertilizer or processed further.

The NH₃ that has formed during the production process is passed into an absorber. By means of subsequent introduction of water into the absorber, the absorbed NH₃ can be transferred back into solution and passed into the tank storage unit. In this regard, the concentration of NH₃ in the solution can be adjusted precisely, so that a high yield of ammonium hydrogen carbonate is obtained.

In the tank storage unit, NH₃ is available again to the method for the production of fertilizers. Because the NH₃ is obtained in this production process, it is therefore not necessary to make additional NH₃ available.

It is advantageous if the oxidation agent is a peroxide and the aqueous solution is an H₂SO₄ solution. In this aqueous solution containing the peroxide, SO₂ is oxidized to SO₄²⁻, and NOₓ is oxidized to NO₃⁻. Particularly preferably, H₂O₂ is used as a peroxide, because H₂O₂ is quite easy to handle and can be obtained inexpensively. However, permanganate or ozone can also be used as an oxidation agent, wherein preferably, KMnO₄ is used, because KMnO₄ is nontoxic and easy to handle.

In a third container, the acidic solution containing SO₄²⁻ and/or NO₃⁻ is mixed with a solution containing NH₃ and thereby neutralized.

This neutralized solution is passed into a crystallization apparatus, in which NH₄NO₃ and/or (NH₄)₂SO₄ crystallize out. The substances obtained in this manner demonstrate great purity, wherein, of course, recrystallization can still take place in order to remove possible foreign substances.

The two solids NH₄NO₃ and/or (NH₄)₂SO₄ are separated from the solution and subsequently dried. NH₄NO₃ or (NH₄)₂SO₄, respectively, can in turn be used as a fertilizer that contains nitrogen.

Ammonium hydrogen carbonate, NH₄NO₃ and/or (NH₄)₂SO₄ are used as fertilizers. It is therefore an advantage of the method that all the exhaust gases are processed further, so that no gas, particularly no CO₂, NOₓ or SO₂ gets into the atmosphere.

The invention will be described using figures, and will be explained in greater detail below. The figures show:

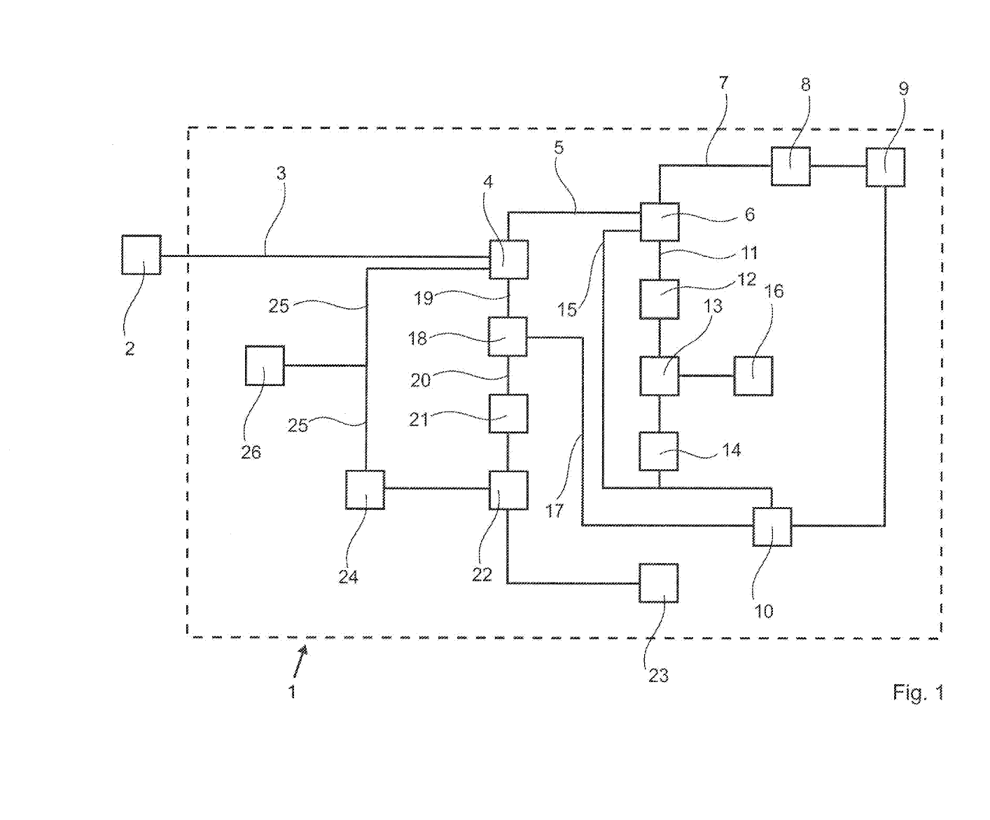

FIG. 1 a schematic representation of the apparatus for the production of fertilizers, and

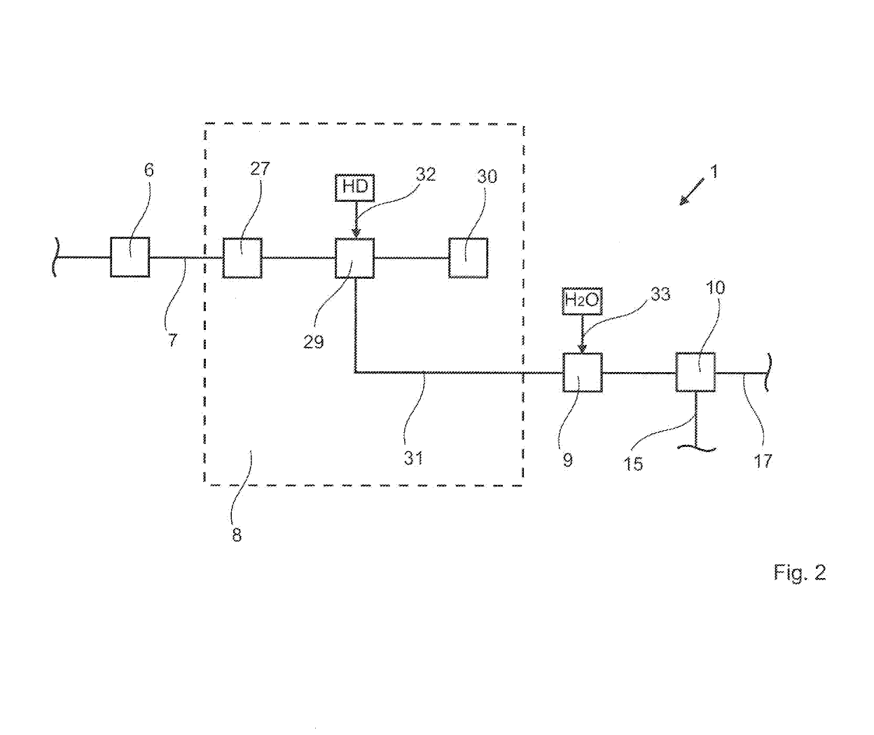

FIG. 2 a schematic representation of a system for the production of NH₃, which is part of the apparatus according to FIG. 1.

FIG. 1 shows an apparatus 1 for the production of fertilizers from exhaust gases of a production system 2. This production system 2 can be, for example, a system for cement production or a system for metal production. If the exhaust gas comes from a system for cement production, the exhaust gas contains CO₂, N₂, NOₓ, and SO₂. If it involves smelter gas that occurs during metal production, this gas can contain CO₂, N₂ as well as SO₂, for example. Formulated in general, the exhaust gas can therefore contain CO₂, N₂ as well as NOₓ and/or SO₂.

In the exemplary embodiment shown in FIG. 1, the production system 2 is a system for cement production, so that the exhaust gas contains CO₂, N₂, NOₓ, and SO₂, wherein NOₓ can have 95% NO and 5% NO₂, for example. In this regard, the exhaust gas that occurs during cement production is passed into a first container 4 by way of a first line 3, wherein the container 4 can be a reactor. In the reactor 4, there is an acidic solution containing an oxidation agent, e.g. KMnO₄, O₃ or a peroxide. In the container 4, NOₓ as well as SO₂ are oxidized, whereas CO₂ and N₂ are not oxidized and leave the container 4 by way of a second line 5. By way of this second line 5, CO₂ and N₂ get into a second container 6. In this second container 6, a solution containing NH₃ is presented, through which the gas mixture containing CO₂ and N₂ is passed. In this regard, the temperature in the second container 6 can be adjusted in such a manner that on the basis of the kinetics, NH₃ and CO₂ react in the solution to form ammonium hydrogen carbonate (NH₄HCO₃), wherein the ammonium hydrogen carbonate essentially remains dissolved in the aqueous solution.

NH₃+CO₂+H₂O→NH₄HCO₃ (I)

In this regard, the reaction temperature in the container 6 lies between 303 and 313 K and preferably at 308 K.

Aside from NH₄HCO₃, however, other compounds are also formed as byproducts (Reactions II to VI), as a function of the molar ratios of the educts H₂O, CO₂, and NH₃ as well as of the temperature.

Therefore, on the basis of the following equilibrium

NH₃+CO₂+H₂O [symbol] NH₄⁺+HCO₃⁻ (II)

not only NH4HCO3 but also ammonium carbonate is formed (Reaction (III).

2 NH₄⁺+HCO₃⁻+H₂O [symbol] (NH₄)₂CO₃.H₂O (III)

Furthermore, a carbamic acid is also formed as a byproduct. (Reaction IV).

NH₃+CO₂ [symbol] H₂NCO₂H (IV)

H₂NCO₂H is quite unstable and reacts further with NH₃ to form ammonium carbamate (Reaction V).

NH₃+H₂NCO₂H [symbol] NH₂COONH₄ (V)

Furthermore, a sesqui-carbonate can be formed (Reaction VI).

4 NH₄⁺+2 HCO₃⁻+CO₃²⁻ [symbol] (NH₄)CO₃.2 NH₄HCO₃ (VI)

Depending on the temperature, the byproducts formed under II to VI are present as solids. However, the equilibrium lies very strongly on the side of the educts.

The solution containing ammonium hydrogen carbonate (Reaction I) as well as the other products (see Reactions II to VI) is transferred to a recrystallization apparatus 12 by way of a fourth line 11. In this recrystallization apparatus 12, these products can crystallize out at about 281 to 283 K. If the molar ratio of CO₂ to NH₃ is greater than 0.78, then ammonium hydrogen carbonate is formed almost exclusively. In this regard, recrystallization can take place, wherein on the basis of Gibbs' phase rule, ultimately only a solid phase, namely ammonium hydrogen carbonate, is formed, because this solid represents the most stable compound. It is understood that before the ammonium hydrogen carbonate is crystallized out, the solution can still be degassed.

Cooling of the crystallization apparatus 12 takes place by means of a water/lithium bromide absorption cooling unit. This ammonium hydrogen carbonate is dried, for example in a drying chamber 16. After the ammonium hydrogen carbonate was dried, it can be used as a fertilizer. For this purpose, an additive can additionally be added to the ammonium hydrogen carbonate, so that the ammonium hydrogen carbonate can be stored well and does not decompose. The solution containing the ammonium hydrogen carbonate that has crystallized out is transferred to a chamber 13, in which the solid ammonium hydrogen carbonate is separated from the solution. This can take place, for example, by means of centrifugation. However, ammonium hydrogen carbonate can also be dried in presses or nutsche filters. The mother liquor obtained in this way is passed into a tank storage unit 14 for the mother liquor. This mother liquor can then be passed back into the process circuit and mixed with the solution containing NH₃ that comes from the tank storage unit 10. The solution mixture containing the mother liquor as well as the solution containing NH₃ is introduced, by way of a line 15, into the container 6, once again, in which container CO₂ is mixed with NH₃.

In this regard, N₂ flows through the container 6, without entering into reaction with the NH₃ solution, and leaves the container 6 again by way of a line 7. N₂ is passed into a system 8 for the production of NH₃ by way of this line 7, wherein this system 8 is part of the apparatus 1 for the production of fertilizers from the exhaust gases of the production system 2. The gaseous NH₃ produced in the system 8 is passed into a boiler 9, in which an absorber is disposed, which absorbs the gaseous NH₃. Water can be introduced into this boiler in order to dissolve the NH₃. Therefore a solution containing NH₃ is formed. Therefore a solution containing NH₃ is formed. This NH₃ solution is passed to a tank storage unit 10 for the NH₃ solution.

In the first container 4, an oxidation agent in an acidic solution is provided, preferably a peroxide, and particularly preferably H₂O₂. Further oxidation agents can be O₃ or permanganate, for example KMnO₄. Preferably, an aqueous H₂SO₄ solution is used as the acidic solution. SO₄ reacts with the oxidation agent to form SO₄²⁻, and NO or NO₂ reacts to form HO₃⁻. In this regard, SO₂ is first oxidized to SO₃ in the container 4, wherein SO₃ continues to react, in the acidic solution, to form SO₄²⁻ or HSO₄⁻, depending on the pH.

NO is oxidized by the oxidation agent that is present, to form NO2, at least in part, wherein NO and NO₂ react in the aqueous H₂SO₄ solution to form NO₂⁻. Finally, NO₂⁻ is reacted further by the oxidation agent, to form NO₃⁻.

The apparatus 1 also comprises a third container 18, into which a solution containing NH₃ can be passed by way of a fifth line 17. The NH₃ solution comes from the tank storage unit 10. In this regard, the NH₃ solution is presented as a base, in order to neutralize the acidic solution containing NO₃⁻ as well as SO₄²⁻.

As soon as the NH₃ solution was presented, the solution containing NO₃⁻ as well as SO₄²⁻ is added by way of a third line 19. In this regard, the solution from the first container 4 can be pumped into the third container 18. Subsequently, the solution from the container 18 is transferred to a crystallization apparatus 21 by way of a further line 20, for example by means of pumping the solution into the crystallization apparatus 21. In this crystallization apparatus 21, NH₄NO₃ and (NH₄)₂SO₄ are crystallized out at a low temperature, preferably at a temperature of 278 to 288 K, and particularly preferably at a temperature of 261 to 283 K. In this regard, cooling takes place by means of the water/lithium bromide absorption cooling unit. NH₄NO₃ and (NH₄)₂SO₄ can additionally still be recrystallized in order to obtain NH₄NO₃ and (NH₄)₂SO₄ in pure form. The solution containing the crystals of NH₄NO₃ and (NH₄)₂SO₄ are introduced into a further container 22. In this container 22, the solids are separated from the solution and subsequently dried. Separation of the solution can take place, for example, in one or more centrifuges. In this regard, the solids can be dried in a drying chamber 23. The energy for drying of these solids can be obtained from the water/lithium bromide absorption cooling unit. NH₄NO₃ and (NH₄)₂SO₄ can be used as fertilizers or can be added to a fertilizer mixture. The solution chat has been separated (mother liquor) is subsequently introduced into a tank storage unit 24. The mother liquor can be mixed with the oxidation agent contained in the acidic solution in a further line 25, and passed into the first container 4 by way of this line 25. For this purpose, the oxidation agent contained in the acidic solution is made available in a storage tank 26.

Because SO₂ is completely reacted to form (NH₄)₂SO₄, it is also possible to use educts that have a high sulfur content in the production systems, because the environment is not burdened with gases that contain sulfur. Also, burdening of the environment with NOₓ also does not take place, because this gas is also completely reacted.

FIG. 2 shows a schematic representation of a system 8 for the production of NH₃, which is part of the apparatus 1 according to FIG. 1. The nitrogen that comes from the second container 6 is passed into a reactor 27, in which CaC₂ was presented. Preferably, N₂ is purified to remove trace gases before this gas is passed into the reactor 27, but this is not shown in FIG. 2. Azotization takes place at a temperature above 1023 K, preferably at a temperature above 1273 K, during which process CaCN₂ is formed. CaCN₂ is introduced into a further reactor 29, in which CaCN₂ is hydrolyzed (Reaction VII), wherein NH₃ and CaCO₃ are formed. For this purpose, hot steam (HD) is passed into the reactor 29 (arrow 32), in other words steam that has a temperature of 573 to 873 K is introduced into the reactor 29.

CaCN₂+3 H₂O→CaCO₃ (s)+2 NH₃ (g) (VII)

CaCO₃ occurs as a solid and can therefore easily be removed from the reactor 29. After drying of the CaCO₃, for example in a drying chamber 30, CaCO₃ can be used for the production of fertilizers or, once again, as an educt in the production system, for example in a system for cement production.

The gaseous NH₃ is passed into the absorber 9 by way of a line 31, which—like the other lines of the apparatus 1—can be a pipe. There, NH₃ is absorbed. Now, a solution containing NH₃ can be produced by means of supplying H₂O (arrow 33), which solution can subsequently be passed into the tank storage unit 10. The solution containing NH₃, made available in the tank storage unit 10, can now be made available to the method for the production of fertilizers, once again.

Alternatively, however, it is also possible to do without hydrolysis of CaCN₂ and to use CaCN₂ as a fertilizer.

### REFERENCE SYMBOL LIST

1 apparatus

2 production system

3 line

4 container

5 line

6 container

7 line

8 system

9 boiler

10 tank storage unit

11 line

12 crystallization apparatus

13 chamber

14 tank storage unit

15 line

16 drying chamber

17 line

18 container

19 line

20 line

21 crystallization apparatus

22 container

23 drying chamber

24 tank storage unit

25 line

26 storage rank

27 reactor

28 -

29 reactor

30 drying chamber

31 line

32 arrow

33 arrow

1-21. (canceled)

22: Apparatus for the production of fertilizers from exhaust gases of a production system, wherein
the apparatus (1) has a first container (4), which is connected with the production system (2) by way of a first line (3), wherein an exhaust gas from the production system (2) can be introduced into the first container (4), wherein the exhaust gas contains CO₂, N₂ as well as NOₓ and/or SO₂;
in the first container (4), N₂, and CO₂ can be separated from NOₓ and/or SO₂,
the first container (4) is connected with a second container (6) by way of a second line (5), wherein CO₂ and N₂ can be transferred to the second container (6) by way of the second line (5), and
a solution containing NH₃ can be introduced into the second container (6) by way of a third line (15), wherein the temperature in the second container (6) can be adjusted in such a manner that NH₃ and CO₂ react in the solution to form ammonium hydrogen carbonate, wherein the solution containing ammonium hydrogen carbonate can be transferred to a crystallization apparatus (12) by way of a fourth line (11), and wherein ammonium hydrogen carbonate can be crystallized out in this crystallization apparatus (12).

23: Apparatus according to claim 22, wherein in the first container (4), an oxidation agent is provided, which oxidizes NOₓ and/or SO₂, wherein the oxidation produces of NOₓ and/or SO₂ remain in the solution.

24: Apparatus according to claim 23, wherein the solution can be transferred from the first container (4) to a third container (18), and wherein this solution can be neutralized in the third container (18) by means of a solution containing NH₃.

25: Apparatus according to claim 22, wherein a tank storage unit (10) is provided, in which the solution containing NH₃ is made available, and wherein the tank storage unit (10) is connected with the second container (6) by way of the third line (15) and with the third container (18) by way of a fifth line (17).

26: Apparatus according to claim 22, wherein the production system (2) is a system for cement production and/or a system for metal production.

27: Apparatus according to claim 23, wherein the oxidation agent is a peroxide, ozone or permanganate.

28: Method for the production of fertilizers from exhaust gases of a production system, comprising the following consecutive steps:
a) in a first container of the apparatus, an oxidation agent is made available in an aqueous acid;
b) an exhaust gas that comes from a production system is passed into the first container, wherein the exhaust gas contains CO₂, N₂ as well as NOₓ and/or SO₂;
c) NOₓ and/or SO₂ are oxidized, while CO₂ and N₂ are conducted into a second container;
d) in the second container, CO₂ reacts with a solution containing NH₃ made available in the second container, to form ammonium hydrogen carbonate.
e) the solution containing ammonium hydrogen carbonate is passed into a crystallization apparatus, in which ammonium hydrogen carbonate crystallizes out.

29: Method according to claim 28, wherein recrystallization takes place in the crystallization apparatus, and thereby pure ammonium hydrogen carbonate is obtained.

30: Method according to claim 29, wherein ammonium hydrogen carbonate is separated from the solution after crystallizing out.

31: Method according to claim 29, wherein the ammonium hydrogen carbonate separated from the solution is dried.

32: Method according to claim 28, wherein N₂ is removed from the second container and processed further to produce NH₃, wherein the method for the production of NH₃ has the following consecutive steps:
a) N₂ is introduced into a reactor containing CaC₂, in which N₂ reacts with CaC₂ to form CaCN₂;
b) CaCN₂ is reacted by means of hot steam, to produce CaCO₃ and NH₃.

33: Method according to claim 32, wherein CaCO₃ is used as an educt in the system for cement production.

34: Method according to claim 32, wherein NH₃ is transferred to an absorber and wherein NH₃ is mixed with water in this absorber, so that a solution containing NH₃ is formed.

35: Method according to claim 34, wherein the solution containing NH₃ is used, once again, for the production of ammonium hydrogen carbonate.

36: Method according to claim 28, wherein the oxidation agent is a peroxide, a permanganate or ozone, and wherein the aqueous acid is a H₂SO₄ solution, SO₂ is oxidized to SO₄²⁻ and/or NOₓ is oxidized to NO₃⁻.

37: Method according to claim 36, wherein the solution containing SO₄²⁻ and/or NO₃⁻ is transferred to a third container, and wherein the solution is mixed, in this container, by means of a solution containing NH₃.

38: Method according to claim 37, wherein the solution is passed into a crystallization apparatus, in which NH₄NO₃ and/or (NH₄)₂SO₄ crystallize out.

39: Method according to claim 38, wherein NH₄NO₃ and/or (NH₄)₂SO₄ are separated from the solution and these solids are subsequently dried.

40: Use of the ammonium hydrogen carbonate, NH₄NO₃ and/or (NH₄)₂SO₄ produced according to the method according to claim 28 as a fertilizer.
